(19) United States
(12) Patent Application Publication
(10) Pub. No.: US 2012/0286560 A1
(43) Pub. Date: Nov. 15, 2012

(54) WHEEL COVER FOR A VEHICLE

(75) Inventor: Kil Jeong Lee, Hwaseong-si (KR)

(73) Assignee: CS SOLUTION CO., LTD., Hwaseong-si (KR)

(21) Appl. No.: 13/500,712

(22) PCT Filed: Dec. 29, 2010
(86) PCT No.: PCT/KR2010/009465

§ 371 Date: Apr. 6, 2012

(30) Foreign Application Priority Data
Jan. 8, 2010 (KR) 10-2010-0001973

(51) Int. Cl. B60B 7/20

(52) U.S. Cl. 301/37.25

(57) ABSTRACT

The present invention relates to a wheel cover which does not rotate and which is maintained stationary when a driving wheel of a vehicle rotates. The wheel cover for a vehicle according to the present invention comprises: a rotating member mounted on the driving wheel of the vehicle so as to rotate together with the driving wheel when the driving wheel rotates; a first fixing member which is connected to the rotating member such that the first fixing member is independently rotatable, and which is provided with a deceleration weight; and a second fixing member such that the second fixing member is independently rotatable, and which is provided with an advertisement unit. The first fixing member attenuates the rotating force being transferred to the second fixing member to thereby prevent the second fixing member from rotating during the rotation of the rotating member.

### TECHNICAL FIELD

The present invention relates to a wheel cover for a vehicle, and particularly, to a wheel cover for a vehicle, which is installed at a wheel so as to be not rotated together with the wheel and thus to be maintained in a stationary state and which is provided with an advertisement unit.

### BACKGROUND ART

Generally, a wheel cover for covering an outer surface of a wheel functions to prevent foreign substances from being introduced to the wheel and also to improve appearance of the vehicle. Some automobile manufacturers may engrave their own brand marks on the wheel cover in order to obtain advertising effect.

FIG. 1 is a longitudinal cross-sectional view of a conventional wheel cover for a vehicle.

As shown in FIG. 1, the conventional wheel cover 10 is overall formed into a circular plate shape similar to a shape of a center portion of the wheel W.

A rim protrusion 11 is formed on one surface of the wheel cover 10 so as to be coupled with the wheel W, and a logo part 20 on which advertisement content such as a brand mark of its manufacturer is printed or integrally injection-molded is formed on the other surface of the wheel cover 10.

However, the conventional wheel cover 10 is fixed to the wheel and thus rotated together with rotation of the wheel. Therefore, when a vehicle runs fast, the wheel cover 10 is also rotated fast, and it makes difficult to recognize visually the contents of the logo part 20.

### DISCLOSURE

### [Technical Problem]

An object of the present invention is to provide a wheel cover for a vehicle, which prevents the wheel cover from being rotated together with the wheel to thereby recognize a mark or a company name displayed on the wheel cover.

### [Technical Solution]

To achieve the object of the present invention, the present invention provides a wheel cover for a vehicle, including a rotating member which is mounted on a wheel of the vehicle so as to be rotated together with the wheel when the driving wheel is rotated; a first fixing member which is connected to the rotating member so as to be independently rotatable, and which is provided with a deceleration weight; a second fixing member which is connected to the first fixing member so as to be independently rotatable and which is provided with an advertisement unit and also formed with a second insertion shaft protruded toward the first fixing member; a first bearing which is disposed between the first fixing member and the rotating member such that the first fixing member and the rotating member are connected to be rotated independently from each other; a second bearing which is disposed between the first fixing member and the second insertion shaft such that the first fixing member and the second insertion shaft are connected to be rotated independently from each other; and a directional weight which is installed at the second fixing member, wherein a center point of gravity of the second fixing member is located on a vertical line to a rotational center of the second fixing member, and the center point of gravity of the second fixing member is located to be closer to an outer circumference of the second insertion shaft than an outer circumference of the second fixing member, and two directional weights are provided to be symmetric with respect to the rotational center of the second fixing member.

Preferably, a first fixing portion is formed at a rear side of the rotational member so as to be protruded and connected to the wheel, and a second fixing portion is formed at an inner circumference of the wheel, and a fixing ring which has an oval shape in section and functions to couple the rotational member and the wheel to each other so that the rotational member and the wheel are rotated together is installed at the first and second fixing portions, and a first fixing groove in which an inner circumference of the fixing ring is inserted is formed in an outer circumference of the first fixing portion so as to be passed through in a circumferential direction of the rotational member, and the a second fixing groove in which an outer circumference of the fixing ring is inserted is formed in an outer circumference of the first fixing portion so as to be opposed to the first fixing groove.

Preferably, a stopper inserted into a stopping groove formed in the inner circumference of the wheel so as to have a trapezoidal shape of which an inner width becomes narrow from a front side toward a rear side thereof is protruded on an outer surface of the rotating member, thereby preventing the rotating member from being rotated independently with respect to the wheel.

Preferably, a first fixing portion is formed at a rear portion of the rotating member so as to be protruded and connected to the wheel, and a second fixing member is formed on the inner circumference of the wheel, and the first fixing portion comprises an extended portion which is extended backward, a hooking portion which is slantly bent from a rear end of the extended portion toward the outer circumference of the rotating member, and the second fixing portion is formed into a trapezoidal shape and protruded from the inner circumference of the wheel toward the first fixing portion, and a rear surface of the second fixing portion comes into contact with the hooking portion and prevents the rotating member from being moved to a front side of the wheel, and the first fixing portion is separated from the rotating member and fastened to a rear portion of the rotating member by a screw.

Preferably, the first fixing member comprises a first connecting portion which is protruded to and inserted into the rotating member; a second connecting portion which is protruded in an opposite direction of the rotating member and inserted into the second insertion shaft of the second fixing member; and a deceleration weight which is disposed between the first and second connecting portions to be protruded to a lower side of a rotational center of the first fixing member, and the first bearing is disposed between the inner circumference of the rotating member and the outer circumference of the first connecting portion, and the second bearing is disposed between the inner circumference of the second insertion shaft and the outer circumference of the second connecting portion.

Preferably, the first fixing member comprises a connecting portion which is inserted into the second insertion shaft of the second fixing member and has an installation groove formed therein; and a deceleration weight which is disposed to be protruded to a lower side of a connecting portion, and a third insertion shaft which is inserted into the installation groove is formed in the rotating member, and the first bearing is disposed between an inner surface of the installation groove and an outer circumference of the third insertion shaft, and the second bearing is disposed between the inner circumference of the second insertion shaft and an outer circumference of the connecting portion.

### [Advantageous Effects]

According to the present invention as described above, the two bearings are disposed between the wheel and the wheel cover so as to minimize the movement of the wheel cover upon the rotation of the wheel, such that the wheel cover is maintained in a stationary state, and thus it makes possible to recognize clearly the advertisement unit attached on the wheel cover.

### DESCRIPTION OF DRAWINGS

The above and other objects, features and advantages of the present invention will become apparent from the following description of preferred embodiments given in conjunction with the accompanying drawings, in which:

FIG. 1 is a longitudinal cross-sectional view of a conventional wheel cover for a vehicle.

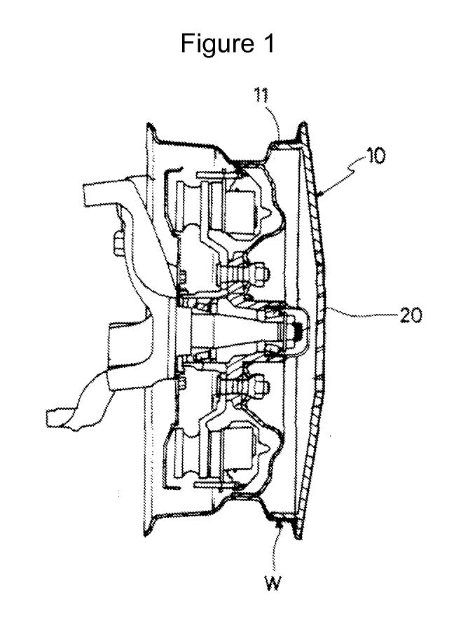

FIG. 2 is a perspective view of a wheel and a wheel cover for a vehicle according to a first embodiment of the present invention.

FIG. 3 is an exploded perspective view of the wheel cover shown in FIG. 2 when seeing it from one side.

FIG. 4 is an exploded perspective view of the wheel cover shown in FIG. 2 when seeing it from the other side.

FIG. 5 is a perspective view of the wheel on which the wheel cover of FIG. 1 is mounted.

FIG. 6 is a cross-sectional view taken along a line A-A of FIG. 5.

FIG. 7 is a cross-sectional view showing a coupling state between first and second fixing parts according to another embodiment of the present invention.

FIG. 8 is an exploded perspective view of a wheel cover for a vehicle according to a second embodiment of the present invention.

FIG. 9 is an exploded perspective view of the wheel cover of FIG. 8 when seeing it from the other side.

FIG. 10 is a cross-sectional view showing a coupling state of the wheel cover of FIG. 8.

FIG. 11 is a cross-sectional view taken along a line B-B of FIG. 10.

FIG. 12 is a cross-sectional view taken along a line C-C of FIG. 10.

FIG. 13 is a perspective view of a first fixing member according to a third embodiment of the present invention.

FIG. 14 is a cross-sectional view of a wheel cover for a vehicle according to the third embodiment of the present invention.

FIG. 15 is a cross-sectional view of a wheel cover for a vehicle according to a fourth embodiment of the present invention.

FIG. 16 is a cross-sectional view of a wheel cover for a vehicle according to a fifth embodiment of the present invention.

### BEST MODE

Hereinafter, the embodiments of the present invention will be described in detail with reference to accompanying drawings.

### First Embodiment

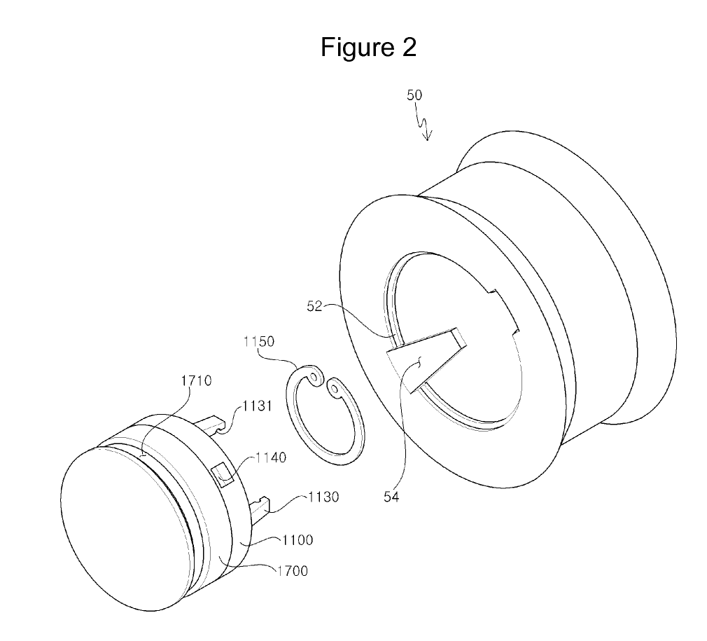

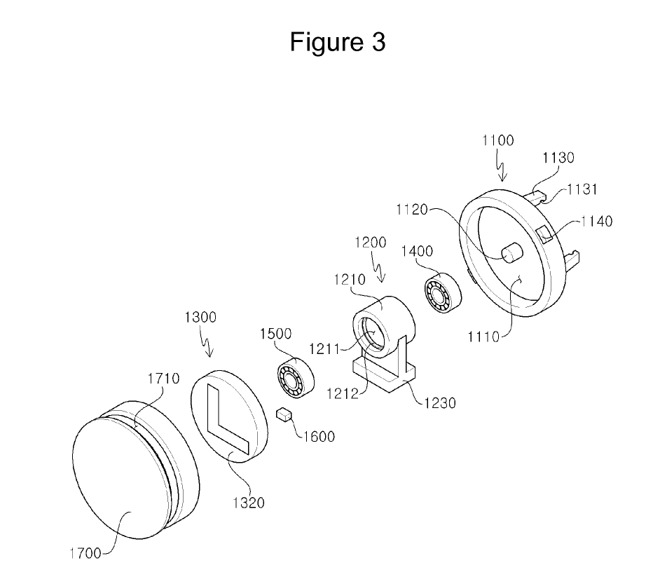

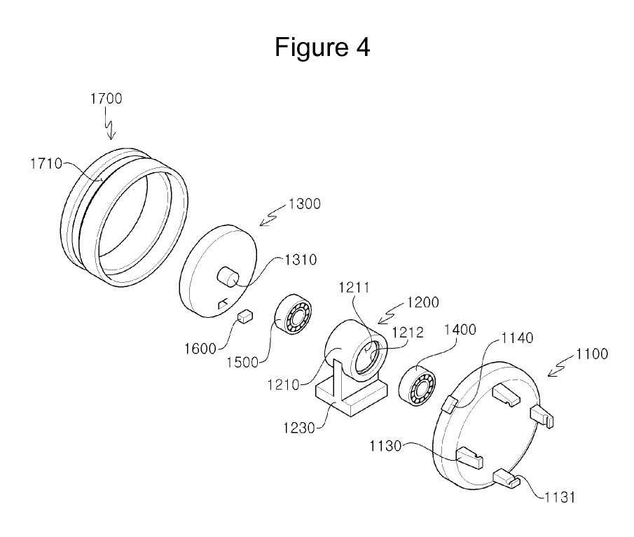

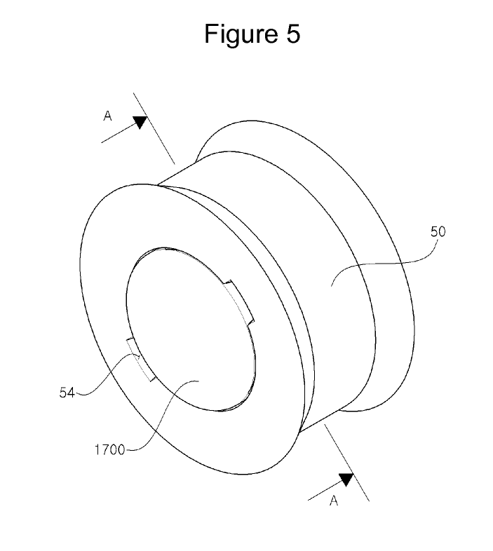

As shown in FIGS. 2 to 6, a wheel cover for a vehicle according to a first embodiment of the present invention includes a rotating member 1100, a first fixing member 1200, a second fixing member 1300, a first bearing 1400, a second bearing 1500, a directional weight 1600 and a protective cover 1700.

The rotating member 1100 is formed into a circular shape, and a first circular insertion portion 1110 is formed at a front side of the rotating member 1100 where the second fixing member 1300 is disposed. And as described later, a first insertion shaft 1120 which is inserted into an installation portion 1211 of the first fixing member 1200 is formed in an inside portion of the first insertion portion 1110.

The first insertion shaft 1120 is formed into a cylindrical shape so as to be protruded toward the front side, and also disposed coaxially with a rotational center of the rotating member 1100. And a first fixing portion 1130 which is protruded to the wheel 50 so as to be connected with the wheel 50 is formed at a rear side of the rotating member 1100.

The four first fixing portions 1130 are provided so as to be spaced apart at regular intervals along the circumference of the rotating member 1100, and a first fixing groove 1131 in which a fixing ring 1150 is inserted is formed in an outer surface of the first fixing portion 1130. The first fixing groove 1131 is formed in a circumferential direction of the rotating member 1100.

The fixing ring 1150 is a snap ring which is formed into a circular shape along the outer surfaces of the four first fixing portions 1130. Further, the fixing ring 1150 has an oval shape in section and is inserted into a second fixing portion 51 formed on an inner surface of a wheel 50.

The four second fixing portions 51 are provided to be spaced apart from each other, and disposed in a circumferential direction of the wheel 50 to be alternated with the first fixing portions 1130. That is, each first fixing portion 1130 is arranged between the second fixing portions 51.

The second fixing portion 51 is formed with a second fixing groove 53 in which the fixing ring 1150 is inserted. The second fixing groove 53 is formed in a circumferential direction of the wheel 50 so as to be opposed to the first fixing groove 1131.

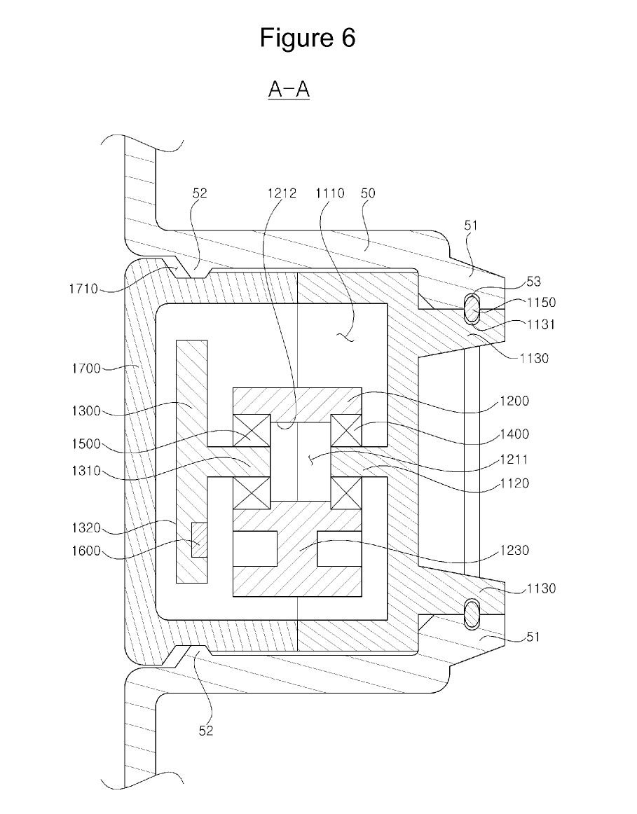

The fixing ring 1150 installed in the first fixing groove 1131 is fixedly inserted into the second fixing groove 53 such that the rotating member 1100 is rotated with the wheel 50. In other words, as shown in FIG. 6, the inner circumference of the fixed ring 50 is inserted into the first fixing groove 1131 and the outer circumference thereof is inserted into the second fixing groove 53, such that the rotating member 1100 and the wheel 50 are coupled with each other and thus rotated together.

Further, as shown in FIG. 2, a stopper 1140 which is inserted into the wheel 50 is formed on an outer surface of the rotating member 1100. The stopper 1140 is formed into a rectangular shape and protruded from the outer surface of the rotating member 1100 toward the wheel 50. The stopper 1140 is inserted into a stopping groove 54 formed on an inner circumference of the wheel 50, as shown in FIG. 2, such that the rotating member 1100 is prevented from being rotated independently from the wheel 50.

The stopping groove 54 is formed in the inner circumference of the wheel 50 and formed into a trapezoidal shape of which an inner width becomes narrow from a front side toward a rear side thereof. Further, the rear width of the stopping groove 54 is formed to be the same as or less than a width of the stopper 1140.

The stopper 1140 is moved from the front side to the rear side of the stopping groove 54 when the rotating member 1100 is installed in the wheel 50. The stopper 1140 comes into contact with both rear side surfaces of the stopping groove 54 and functions to prevent the rotating member 1100 from being rotated independently with respect to the wheel 50.

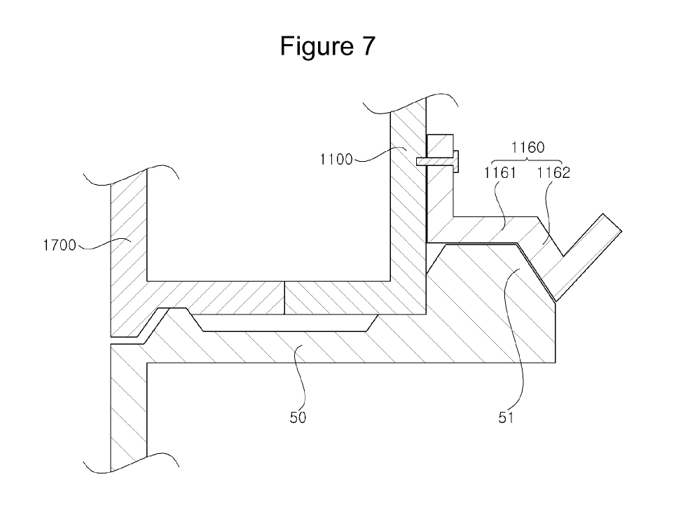

Further, in some cases, as shown in FIG. 7, first and second fixing portions 1160 and 55 may be hooked to each other without using of the fixing ring 1150.

More detailedly, the first fixing portion 1160 includes an extended portion 1161 which is extended backward, and a hooking portion 1162 which is slantly bent from a rear end of the extended portion 1161 toward the outer circumference of the rotating member 1100.

Further, the first fixing portion 1160 is separately formed from the rotating member 1100 and fastened to a rear side of the rotating member 1100 by using a screw or the like. If necessary, the first fixing portion 1160 may be formed integrally with the rotating member 1100.

The second fixing portion 51 is formed into a trapezoidal shape which is protruded from the inner circumference of the wheel 50 toward the first fixing portion 1160. A rear surface of the second fixing portion 51 comes into contact with the hooking portion 1162 and functions to prevent the rotating member 1100 from being moved to the front side of the wheel 50.

Of course, the rotating member 1100 and the wheel 50 may be coupled to each other in various one-touch manners besides the hooking manner.

The first fixing member 1200 is formed into cylindrical shape, disposed between the rotating member 1100 and the second fixing member 1300 and connected to the rotating member 1100 and the second fixing member 1300 so as to be independently rotated.

Detailedly, the first fixing member 1200 includes a connecting portion 1210 and a deceleration weight 1230 which is protruded to a lower side of the connecting portion 1210.

The connecting portion 1210 is formed into a cylindrical shape and disposed coaxially with the first insertion shaft 1120. The connecting portion 1210 is formed with an installation groove 1211 of which front and rear sides are opened, and the installation groove 1211 is formed into a cylindrical shape, and the first insertion shaft 1120 is inserted into the installation groove 1211.

A stepped portion 1212 of which an inner diameter is smaller than an inner diameter of the installation groove 1211 is formed in an inner circumference of the installation groove 1211. The stepped portion 1212 is formed to be protruded along the inner circumference of the installation groove 1211 and also to be arranged at a center portion of the installation groove 1211.

As described below, the stepped portion 1212 is contacted with each of first and second bearings 1400 and 1500 so as to prevent the first and second bearings 1400 and 1500 from being moved to the front and rear sides of the installation groove 1211.

The deceleration weight 1230 is formed into a rectangular shape which is protruded to the lower side of the connecting portion 1210. A lower width of the deceleration weight 1230 is larger than an upper width thereof, and thus an upper weight thereof is larger than a lower weight thereof. The deceleration weight 1230 functions to pull down the first fixing member 1200 using the force of gravity, thereby preventing the first fixing member 1200 from being rotated.

The second fixing member 1300 is formed into a circular shape, and a second insertion shaft 1310 formed into a circular shape is formed at a rear portion of the second fixing member 1300, i.e., towards the rotating member 1100. The second insertion shaft 1310 is disposed coaxially with a rotational center of the connecting portion 1210 and inserted into the installation groove 1211 of the connecting portion 1210.

Further, an advertisement unit 1320 is provided at a front side of the second fixing member 1300. The advertisement unit 1320 is integrally formed with the second fixing member 1300, such that a logo of a manufacturer, an advertising copy or the like can be displayed. Of course, if necessary, the advertisement unit 1320 may be detachably installed at the second fixing member 1300.

Meanwhile, the first bearing 1400 is formed into a hollow circular shape and disposed between the outer circumference of the first insertion shaft 1120 and the inner surface of the installation groove 1211. That is, the first insertion shaft 1120 is inserted into the first bearing 1400 so that an inner circumference of the first bearing 1400 is coupled with the outer circumference of the first insertion shaft 1120, and also the first bearing 1400 is inserted into the installation groove 1211 so that an outer circumference of the first bearing 1400 is coupled with the inner surface of the installation groove 1211.

When the rotating member 1100 is rotated, the first bearing 1400 allows the first fixing member 1200 to be slid in an circumferential direction of the first insertion shaft 1120, thereby attenuating rotational force transmitted from the rotating member 1100 to the first fixing member 1200, and also allows the rotating member 1100 to be rotated independently with respect to the first fixing member 1200.

The first bearing 1400 is disposed at a rear side of the installation groove 1211. An outer diameter of the first bearing 1400 is larger than an inner diameter of the stepped portion 1212, and thus it is prevented by the stepped portion 1212 that the first bearing 1400 is prevented from being moved toward the front side thereof.

The second bearing 1500 is also formed into a hollow circular shape and disposed between the outer circumference of the second insertion shaft 1310 and the inner surface of the installation groove 1211. That is, the second insertion shaft 1310 is inserted into the second bearing 1500 so that an inner circumference of the second bearing 1500 is coupled with the outer circumference of the second insertion shaft 1310, and the second bearing 1500 is inserted into the installation groove 1211 so that an outer circumference of the second bearing 1500 is coupled with the inner surface of the installation groove 1211.

When the rotating member 1100 is rotated, the second bearing 1500 allows the second fixing member 1300 to be slid in an circumferential direction of the second insertion shaft 1310, thereby attenuating rotational force transmitted from the first fixing member 1200 to the second fixing member 1300, and also allows the first member 1200 and the second fixing member 1300 to be rotated independently with respect to each other.

Further, the second bearing 1500 is disposed at a front side of the installation groove 1211. An outer diameter of the second bearing 1500 is larger than an inner diameter of the stepped portion 1212, and thus it is prevented by the stepped portion 1212 that the second bearing 1500 is prevented from being moved toward the rear side thereof.

The first bearing 1400 is disposed between the inner surface of the installation groove 1211 and the outer circumference of the first insertion shaft 1120, and the second bearing 1500 is disposed between the inner surface of the installation groove 1211 and the outer circumference of the second insertion shaft 1310. Therefore, the connecting portion 1210 becomes larger than the first and second bearings 1400 and 1500, and the whole size of the first fixing member 1200 is increased, and thus force of gravity applied to the first fixing member 1200 is increased and the deceleration effect of the first fixing member 1200 is increased.

Further, the rotating member 1100 is installed at the inner circumference of the first bearing and the first fixing member 1200 is installed at the outer circumference of the first bearing 1400. Therefore, when the rotating member 1100 is rotated, the first fixing member 1200 installed at the outer circumference of the first bearing 1400 is more greatly influenced by centrifugal force than the rotating member 1100 installed at the inner circumference of the first bearing 1400, thereby reducing the rotational force of the rotating member 1100, which is transmitted to the first fixing member 1200.

Meanwhile, the directional weight 1600 is provided at the second fixing member 1300 so as to prevent the second fixing member 1300 from being rotated by movement of the first fixing member 1200 and inertial force generated upon running of a vehicle.

More detailedly, the directional weight 1600 is formed into a rectangular shape and formed of a material which is heavier than the second fixing member 1300. The directional weight 1600 is inserted into a lower side of the rotational center of the second fixing member 1300 so as to be disposed on a vertical line to the rotational center of the second fixing member 1300.

In other words, the directional weight 1600 is disposed at the lower side of the second fixing member 1300 so as to be inserted into a rear surface of the second fixing member 1300 and also disposed to be vertical to the rotational center of the second fixing member 1300.

As described above, since a center point of gravity of the directional weight 1600 is located on a vertical line to the rotational center of the second fixing member 1300, the center of gravity of the second fixing member 1300 is constantly maintained in a vertical direction thereof, and thus it is prevented that the second fixing member 1300 is rotated by the movement of the first fixing member 1200 or the inertial force applied to the second fixing member 1300 when a vehicle runs.

If necessary, two directional weights 1600 may be provided and disposed to be symmetric with respect to the rotational center of the second fixing member 1300, or three directional weights 1600 may be provided and arranged along the circumference of the second fixing member 1300 at an angular interval of 120 degrees. Further, in some cases, the directional weight 1600 may be integrally formed with the second fixing member 1300.

The directional weight 1600 is spaced apart from the outer circumference of the second fixing member 1300 to the second insertion shaft 1310.

The protective cover 1700 is formed into a cylindrical shape and disposed at the front side of the second fixing member 1300 so as to cover the second fixing member 1300 and also to be spaced apart from the second fixing member 1300. Further the protective cover 1700 is formed of a transparent material so that the advertisement unit 1320 installed at the second fixing member 1300 can be shown from an outside.

A separation preventing groove 1710 is formed in an outer circumference of the protective cover 1700. Both ends of the separation preventing groove 1710 are formed to be inclined, and a separation preventing protrusion 52 formed on the inner circumference of the wheel is inserted into the separation preventing groove 1710 when the protective cover 1700 is assembled with the wheel 50, thereby preventing the protective cover 1700 from being separated.

The protective cover 1700 is disposed to be spaced apart from the second fixing member 1300 and also to cover the second fixing member 1300. Therefore, when the rotating member 1100 is rotated, the protective cover 1700 is rotated independently from the second fixing member 1300 so as to prevent foreign substances from being introduced between the rotating member 1100 and the second fixing member 1300, thereby enhancing durability of the wheel cover and preventing damage thereof. Further, since the protective cover 1700 is formed of a transparent material, the contents of an advertisement can be clearly shown through the transparent protective cover 1700.

Further, the first embodiment of the present invention may include other configuration in which the rotating member 1100 and the second fixing member 1300 are connected to each other without the first fixing member 1200 so as to be relatively rotated and the protective cover 1700 is connected with the rotating member 1100 so that a space between the second fixing member 1300 and the rotating member 1100 in which the second fixing member 1300 is disposed can be closed air-tightly.

### Second Embodiment

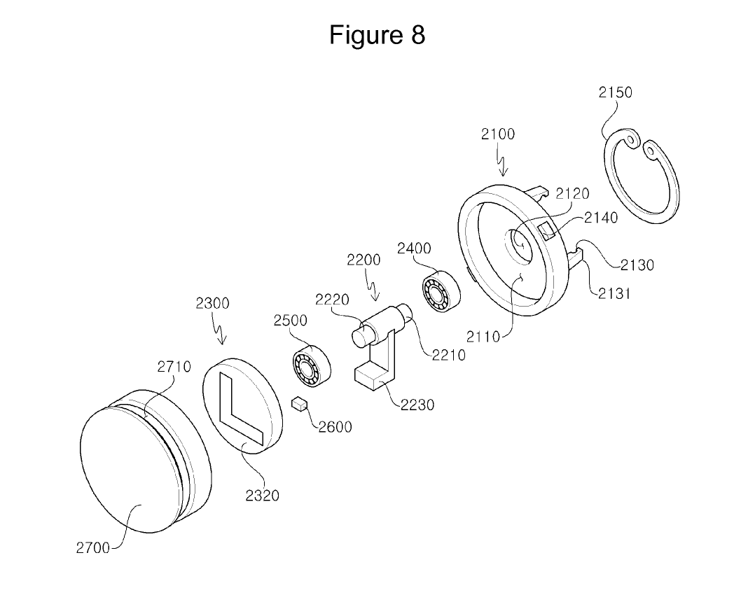

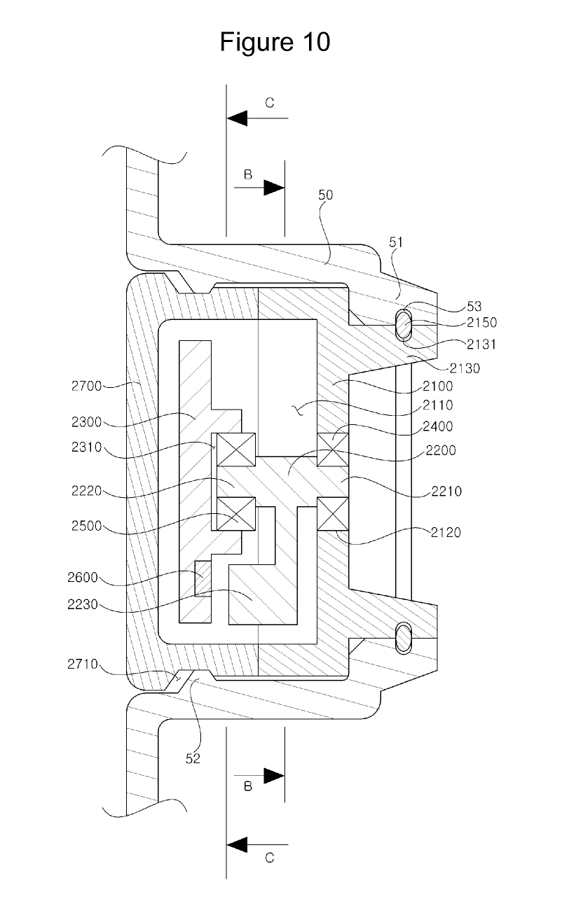

As shown in FIGS. 8 to 12, a wheel cover for a vehicle according to a second embodiment of the present invention includes a rotating member 2100, a first fixing member 2200, a second fixing member 2300, a first bearing 2400, a second bearing 2500, a directional weight 2600 and a protective cover 2700.

The rotating member 2100 is formed into a circular shape, and a first circular insertion portion 2110 is formed at a front side of the rotating member 2100 where the second fixing member 2300 is disposed. And as described later, a second insertion groove 2120 in which the first bearing 2400 is inserted is formed in an inside portion of the first insertion portion 1110.

A first fixing portion 2130 which is protruded to the wheel 50 so as to be connected with the wheel 50 is formed at a rear side of the rotating member 2100. A fixing ring 2150 is installed at the first fixing portion 2130, and the fixing ring 2150 is connected with the second fixing portion 54 of the wheel and functions to fix the rotating member 2100 to the wheels.

The first fixing member 2130, the fixing ring 2150 and the second fixing portion 54 are the same as those in the first embodiment, and thus the description thereof will be omitted.

The first fixing member 2200 is formed into cylindrical shape, disposed between the rotating member 2100 and the second fixing member 2300 and connected to the rotating member 2100 so as to be independently rotated.

Further, the first fixing member 2200 includes a first connecting portion 2210 which is protruded toward the rotating member 2100, i.e., to a rear side thereof, and a second connecting portion 2220 which is protruded in an opposite direction to the rotating member 2100, i.e., toward the second fixing member 2300. The first connecting portion 2210 is inserted into a center portion of the rotating member 2100, and connected to the rotating member 2100 through the first bearing 2400, as described later.

The second connecting portion 2220 is inserted into a first insertion shaft 2310 formed at a center portion of the second fixing member 2300, and connected to the second fixing member 2300 through the second bearing 2500, as described later.

Further, outer diameters of the first and second connecting portions 2210 and 2220 are formed to be smaller than an outer diameter between the first and second connecting portions 2210 and 2220. In other words, an outer circumference between the first and second connecting portions 2210 and 2220 is formed to be stepped with respect to the outer circumferences of the first and second connecting portions 2210 and 2220.

By such stepped portion, the first and second bearings 2400 and 2500 are respectively fixed to the first and second connecting portions 2210 and 2220 of the first fixing member 2200. p Further, a deceleration weight 2230 is provided at a lower portion of a rotational center of the first fixing member 2200. The deceleration weight 2230 is disposed to be protruded downward between the first and second connecting portions 2210 and 2220, and a lower end of the deceleration weight 2230 is thicker than an upper end thereof.

Preferably, the deceleration weight 2230 is heavier than the sum of weights of the first and second connecting portions 2210 and 2220.

The deceleration weight 2230 functions to pull down the first fixing member 2200 using the force of gravity, thereby preventing the first fixing member 2200 from being rotated.

The second fixing member 2300 is formed into a circular shape, and a second insertion shaft 2310 formed into a circular shape is formed at a rear portion of the second fixing member 2300, i.e., towards the rotating member 2100. The second insertion shaft 2310 is formed with a groove in which the second connecting portion 2220 is inserted. The second bearing 2250 and the second connecting portion 2220 of the first fixing member 2200 are inserted into the second insertion shaft 2310.

Further, an advertisement unit 2320 is provided at a front side of the second fixing member 2300. The advertisement unit 2320 is integrally formed with the second fixing member 2300, such that a logo of a manufacturer, an advertising copy or the like can be displayed. Of course, if necessary, the advertisement unit 2320 may be detachably installed at the second fixing member 2300.

Meanwhile, the first bearing 2400 is disposed between the first fixing member 2200 and the rotating member 2100, such that the first fixing member 2200 and the rotating member 2100 are connected to each other so as to be rotated independently with respect to each other.

Like a general ball bearing, the first bearing 2400 is formed into a circular shape and includes a hollow outer ring, an inner ring which is disposed in the outer ring so as to be rotated independently, and a ball which is disposed to reduce friction between the outer and inner rings.

The first bearing 2400 is disposed between the inner circumference of the rotating member 2100 and the outer circumference of the first connecting portion 2110. That is, an outer circumference of the outer ring of the first bearing 2400 is fixed to the inner surface of the first second insertion groove 2120 of the rotating member 2100 and an inner circumference of the inner ring is fixed to the outer circumference of the first connecting portion 2110, such that the rotating member 2100 and the first fixing member 2200 are rotated independently from each other.

The second bearing 2500 has the same structure as the first bearing 2400, and thus description thereof will be omitted.

The second bearing 2500 is disposed between the inner circumference of the second insertion shaft 2310 of the second fixing member 2300 and the outer circumference of the second connecting portion 2220. In other words, the outer circumference of the outer ring of the second bearing 2500 is fixed to an inner surface of a groove formed in the second insertion shaft 2310 and the inner circumference of the inner ring thereof is fixed to the outer circumference of the second connecting portion 2220 of the first fixing member 2200, such that the second fixing member 2300 and the first fixing member 2200 are rotated independently from each other.

Since the first bearing 2400 is disposed between the first fixing member 2200 and the rotating member 2100 and the second bearing 2500 is disposed between the first and second fixing members 2200 and 2300, it is possible to reduce friction between the first fixing member 2200 and the second fixing member 2300 and between the first and second fixing members 2200 and 2300, when the rotating member 2100 is rotated, and thus it is possible to minimize that the rotational force of the rotating member 2100 is transmitted to the first and second fixing members 2200 and 2300.

Further, since the first bearing 2400 is disposed between the inner circumference of the rotating member 2100 and the outer circumference of the first connecting portion 2110 and the second bearing 2500 is disposed between the inner circumference of the second insertion shaft 2310 formed at the second fixing member 2300 and the outer circumference of the second connecting portion 2220, it is possible to simplify the configuration of the wheel cover, thereby reducing a whole size thereof, and also it is facile to assemble and disassemble the wheel cover when replacing the first and second bearings 2400 and 2500 with new ones.

Meanwhile, the directional weight 2600 is installed at the second fixing member 2300 so as to prevent the second fixing member 2300 from being rotated by movement of the first fixing member 2200. A center point of gravity of the directional weight 2600 is located on a vertical line to the rotational center of the second fixing member 2300 and disposed so as to be closer to the outer circumference of the second insertion shaft 2310 than the outer circumference of the second fixing member 2300.

The protective cover 2700 is formed into a cylindrical shape and disposed at the front side of the second fixing member 2300 so as to cover the second fixing member 2300 and also to be spaced apart from the second fixing member 2300. Further the protective cover 2700 is formed of a transparent material so that the advertisement unit 2320 installed at the second fixing member 2300 can be shown from an outside. And a separation preventing groove 21200 is formed in an outer circumference of the protective cover 2700.

Both ends of the separation preventing groove 2120 are formed to be inclined, and a separation preventing protrusion 52 formed on the inner circumference of the wheel is inserted into the separation preventing groove 2120 when the protective cover 2700 is assembled with the wheel 50, thereby preventing the protective cover 2700 from being separated.

The protective cover 2700 is disposed to be spaced apart from the second fixing member 2300 and also to cover the second fixing member 2300. Therefore, when the rotating member 2100 is rotated, the protective cover 2700 is rotated independently from the second fixing member 2300 so as to prevent foreign substances from being introduced between the rotating member 2100 and the second fixing member 2300, thereby enhancing durability of the wheel cover and preventing damage thereof. Further, since the protective cover 2700 is formed of a transparent material, the contents of an advertisement can be clearly shown through the transparent protective cover 2700.

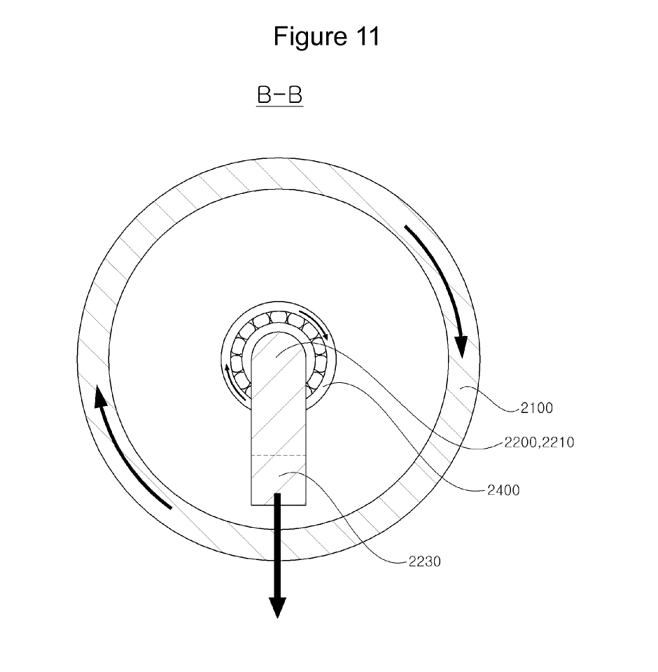

As shown in FIG. 11, in the wheel cover according to the second embodiment of the present invention, when the rotating member 2100 is rotated clockwise, the outer ring of the first bearing 2400 is rotated together with the rotating member 2100, and the inner ring thereof reduces the rotational force of the rotating member 2100 due to friction with the ball.

The rotational force of the rotating member 2100, which is reduced by the first bearing 2400, is transmitted to the first fixing member 2200, and the first fixing member 2200 offsets the rotational force transmitted from the rotating member 2100 using the force of gravity applied to the deceleration weight 2230.

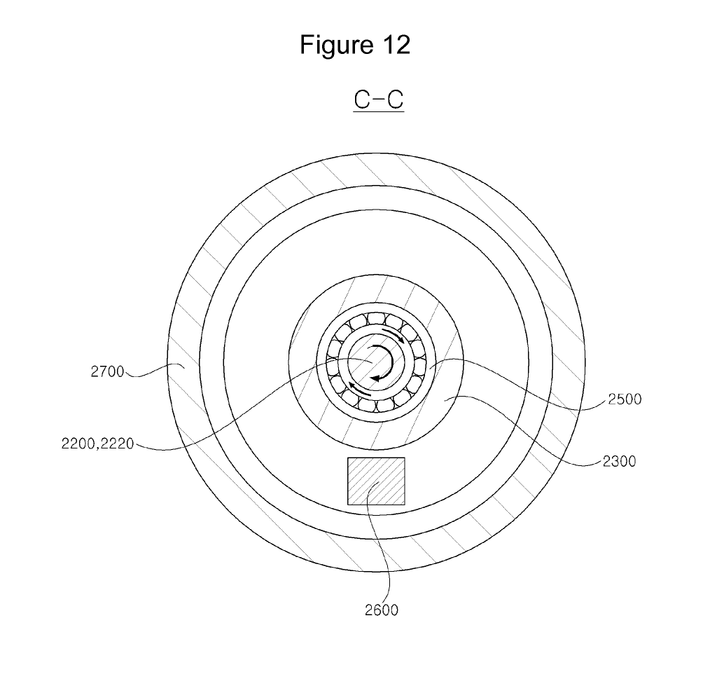

If the rotational force of the rotating member 2100 is not completely offset at the first fixing member 2200 or the first fixing member 2200 is rotated at a desired angle by inertial force, the first fixing member 2200 is rotated together with the inner ring of the second bearing 2500, as shown in FIG. 12, and the outer ring of the second bearing 2500 produces friction with the ball, thereby reducing the rotational force transmitted from the first fixing member 2200.

And the rotational force of the first fixing member 2200, which is reduced by the second bearing 2500, is transmitted to the second fixing member 2300, and the second fixing member 2300 offsets the rotational force transmitted from the first fixing member 2200 using the force of gravity applied to the directional weight 2600.

As described above, since the first fixing member 2200 is connected to the rotating member 2100 so as to be independently rotated and the second fixing member 2300 is connected to the first fixing member 2200 so as to be independently rotated, the rotational force of the rotating member 2100 is offset by the deceleration weight 2230 of the first fixing member 2200. Therefore, the rotation of the second fixing member 2300 is prevented and thus it is facile to recognize the advertisement unit 2320, thereby improving the advertising effect of the advertisement unit 2320.

Further, since the first bearing 2400 is disposed between the first fixing member 2200 and the rotating member 2100 and the second bearing is disposed between the first fixing member 2200 and the second fixing member 2300, the friction between the first and second fixing members 2200 and 2300 is reduced when the rotating member 2100 is rotated, and thus it is possible to minimize the rotational force of the rotating member 2100 transmitted to the first and second fixing members 2200 and 2300.

### Third Embodiment

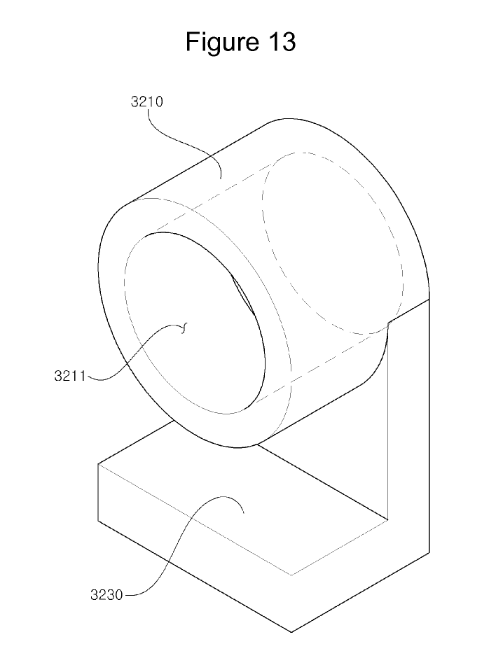

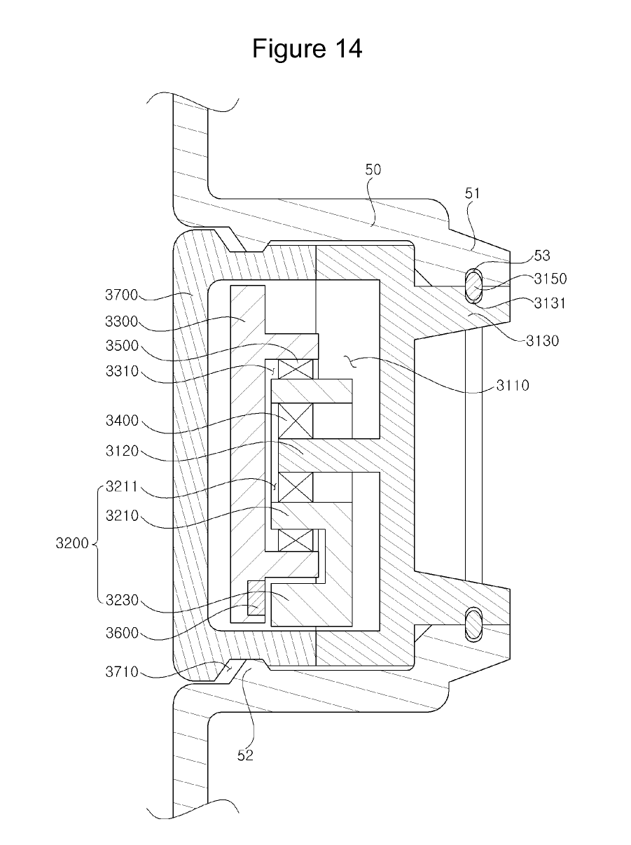

As shown in FIGS. 13 and 14, a wheel cover for a vehicle according to a third embodiment of the present invention includes a rotating member 3100, a first fixing member 3200, a second fixing member 3300, a first bearing 3400, a second bearing 3500, a directional weight 3600 and a protective cover 3700.

The second fixing member 3300, the directional weight 3600 and the protective cover 3700 in the third embodiment are the same as those in the second embodiment, and thus description thereof will be omitted.

The rotating member 3100 is formed into a circular shape and inserted into the vehicle wheel 50 so as to be rotated together when the wheel 50 is rotated. Further, a first circular insertion groove 3110 is formed at a front side of the rotating member 3100 that the second fixing member 3300 is disposed.

A third insertion shaft 3120 is formed at the rotating member 3100 so as to be protruded from the rotational center of the rotating member 3100 to the front side thereof. The third insertion shaft 3120 is formed into a cylindrical shape, and a front end of the third insertion shaft 3120 is inserted into the first fixing member 3200.

Further, a first fixing portion 3130 which is the same as the first fixing portion 1130 of the first embodiment is formed at a rear side of the rotating member 3100. A fixing ring 3150 which is the same as the fixing ring of the first embodiment is installed at the first fixing portion 3150.

The first fixing member 3200 includes a connecting portion 3210 which is inserted into the second insertion shaft 3310 of the second fixing member 3300, and a deceleration weight 3230 which is protruded to a lower side of the connecting portion 3210.

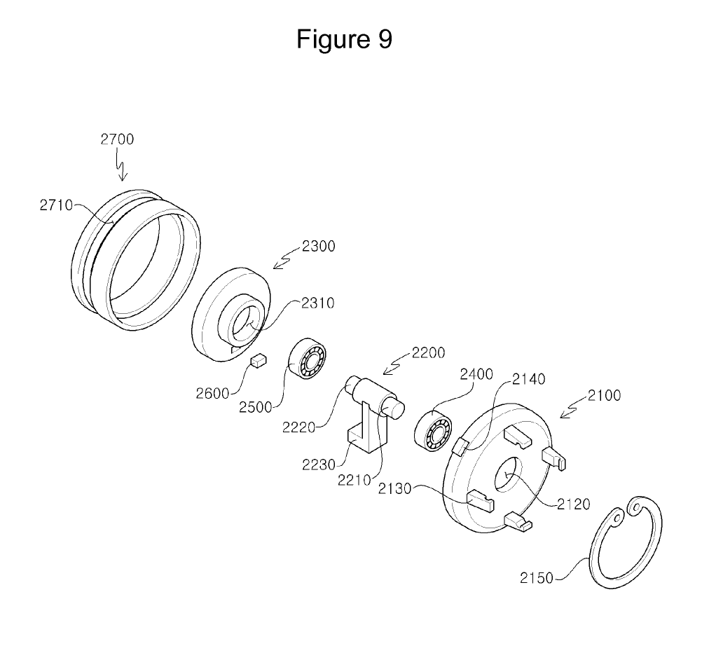

As shown in FIG. 9, the connecting portion 3210 is formed into a cylindrical shape, and an outer diameter thereof is larger than an outer diameter of the third insertion shaft 3120, but smaller than an inner diameter of a groove formed at the second insertion shaft 3310 of the second fixing member 3300.

The connecting portion 3210 is formed with an installation groove 3211 in which the third insertion shaft 3120 is inserted. Front and rear sides of the installation groove 3211 are opened, and an inner diameter thereof is larger than an outer diameter of the third insertion shaft 3120.

The deceleration weight 1230 is formed into a rectangular shape which is disposed at a lower portion of the connecting portion 3210 between the rotating member 3100 and the second fixing member 3300. The deceleration weight 3230 is heavier than the connecting portion 3210 so that a center point of gravity of the first fixing member 3200 is located at a lower portion of the connecting portion 3210.

A lower end of the deceleration weight 3230 is formed to be protruded to the rotating member so as to reduce a space between the second fixing member 3300 and the first fixing member 3200.

The first bearing 3400 is formed into a circular shape which is the same as the first bearing 1400 of the first embodiment and includes an inner ring, an outer ring and a ball. Further, in the first bearing 3400, an outer diameter of the outer ring is the same as or smaller than the inner diameter of the installation groove 3211, and an inner diameter of the inner ring is the same as or larger than the outer diameter of the third insertion shaft.

The first bearing 3400 is disposed between the inner circumference of the installation groove 3211 and the outer circumference of the third insertion shaft 3120 so that the first fixing member 3200 and the rotating member 3100 are connected to be rotated independently from each other. That is, the outer circumference of the outer ring of the first bearing 3400 is fixed to the inner surface of the installation groove 3211, and the inner circumference of the inner ring is fixed to the outer circumference of the third insertion shaft 3120.

The second bearing 3500 has the same configuration as the first bearing 3400, and thus description thereof will be omitted.

Further, in the second bearing 3500, the inner diameter of the inner ring is the same as or larger than the outer diameter of the connecting portion 3210, and the outer diameter of the outer ring is the same or smaller than the inner diameter of the groove formed at the second insertion shaft 3310. The second bearing 3500 is disposed between the inner circumference of the second insertion shaft 3310 and the outer circumference of the connecting portion 3210 so that the second fixing member 3300 and the first fixing member 3200 are connected to be rotated independently from each other.

That is, in the second bearing 3500, the outer circumference of the outer ring is fixed to the inner circumference of the second insertion shaft 3310, and the inner circumference of the inner ring is fixed to the outer circumference of the connecting portion 3210.

And if necessary, the third insertion shaft 3120 may be formed to be protruded from the second fixing member 3300 to the rotating member 3100 and thus to be fixed to the installation groove 1211 of the first fixing member 3200. The first fixing member 3200 may be inserted into the rotating member 3100, and the first bearing 3400 may be disposed between the rotating member 3100 and the connecting portion 3210, and the second bearing 3500 may be disposed between the installation groove 3211 and the third insertion shaft 3120.

In the wheel cover according to the third embodiment of the present invention, as described above, when the rotating member 3100 is rotated together with the wheel 50, the outer ring of the first bearing 3400 is spun with no traction by the ball and thus the rotational force transmitted to the first fixing member 3200 connected to the inner ring is reduced.

The force of gravity due to the deceleration weight 1230 is applied to the first fixing member 3200, and thus the rotational force transmitted from the rotating member 3100 is offset.

If the rotational force of the rotating member 3100 is not completely offset at the first fixing member 3200 or the first fixing member 3200 is rotated at a desired angle by inertial force, the second bearing 3500 and the directional weight 3600 offset the rotational force transmitted from the first fixing member 3200 so that the second fixing member is not rotated.

To this end, a center point of gravity of the directional weight 3600 is located to be closer to the outer circumference of the second insertion shaft 3310 than the outer circumference of the second fixing member 3300.

As described above, since the first bearing 3400 is disposed between the inner surface of the installation groove 3211 and the outer circumference of the third insertion shaft 3120 and the second bearing 3500 is disposed between the inner circumference of the second fixing member 3300 and the outer circumference of the connecting portion 3210, the first and second bearings 3400 and 3500 are disposed in a circumferential direction so as to minimize a space between the rotating member 3100 and the second fixing member 3300, thereby minimizing a whole size of the wheel cover.

### Fourth Embodiment

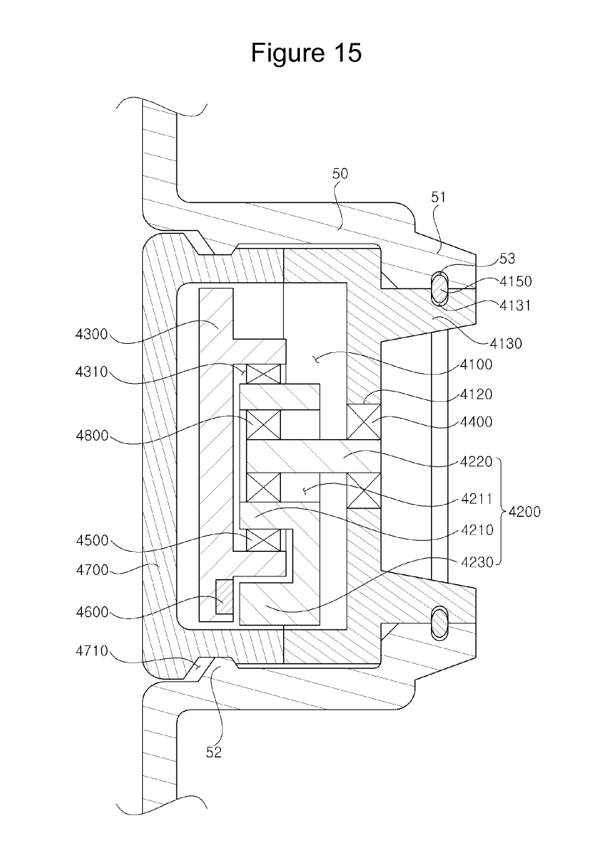

As shown in FIG. 15, a wheel cover for a vehicle according to a fourth embodiment of the present invention includes a rotating member 4100, a first fixing member 4200, a second fixing member 4300, a first bearing 4400, a second bearing 4500, a third bearing 4800, a directional weight 4600 and a protective cover 4700. The rotating member 4100, the second fixing member 4300, the directional weight 4600 and the protective cover 4700 in the fourth embodiment are the same as the rotating member 2100, the second fixing member 2300, the directional weight 2600 and the protective cover 2700 in the second embodiment, and thus description thereof will be omitted.

In the fourth embodiment, the first fixing member 4200 includes a connecting portion 4210, a connecting shaft 4220 and a deceleration weight 4230.

As shown in FIG. 9, the connecting portion 4210 and the deceleration weight 4230 are the same as the connecting portion 3210 and the deceleration weight 3230 in the third embodiment, and thus description thereof will be omitted. Further, the connecting portion 4210 is formed with an installation groove 4211 which is the same as the installation groove 3211 in the third embodiment.

The connecting shaft 4220 is formed into a cylindrical shape which is extended forward and backward, i.e., toward the rotating member 4100 and the second fixing member 4300. One end of the connecting shaft 4220 is inserted into a second insertion groove 4120 of the rotating member 4100, and the other end is inserted into the installation groove 4211 of the connecting portion 4210.

The first, second and third bearings 4400, 4500 and 4800 have the same configuration as the first bearing 2400 of the second embodiment, and thus description thereof will be omitted.

Further, an outer diameter of the first bearing 4400 is the same as or smaller than an inner diameter of the second insertion groove 4120, and an inner diameter thereof is the same as or larger than an outer diameter of the connecting shaft 4220.

The first bearing 4400 is disposed between an inner circumference of the rotating member 4100 and an outer circumference of one end of the connecting shaft 4220 so that the rotating member 4100 and the first fixing member 4200 are connected with each other so as to be rotated independently from each other. That is, an outer circumference of the first bearing 4400 is fixed to the inner surface of the second insertion groove 4120 of the rotating member 4100, and an inner circumference thereof is fixed to the outer circumference of the end of the connecting shaft 4220.

The second bearing 4500 is disposed between an inner circumference of the second fixing member 4300 and an outer circumference of the connecting portion 4210 so that the second fixing member 4300 and the first fixing member 4200 are connected so as to be rotated independently from each other. That is, an outer circumference of the second fixing member 4500 is fixed to the inner surface of a groove formed at the second insertion shaft 4310, and an inner circumference thereof is fixed to the outer circumference of the connecting portion 4210.

The third bearing 4800 is disposed between an inner surface of the installation groove 4211 and an outer circumference of the other end of the connecting shaft 4220 so that the connecting portion 4210 and the connecting shaft 4220 are connected so as to be rotated independently from each other. That is, an outer circumference of the third bearing 4800 is fixed to the inner surface of the installation groove 4211 and an inner circumference thereof is fixed to the outer circumference of the other end of the connecting shaft 4220.

In the wheel cover according to the fourth embodiment of the present invention, when the rotating member 4100 is rotated, the rotational force of the rotating member 4100 is reduced while being transmitted through the first bearing 4400, the connecting shaft 4220 and the third beating 4800, and the fixing member 4200 is supported downward by the deceleration weight 4230 so as to offset the rotational force of the rotating member 4100 transmitted from the third bearing 4800.

Further, if the rotational force transmitted from the third bearing 4800 is not completely offset at the first fixing member 4200 or the first fixing member 4200 is rotated at a desired angle by inertial force, the second bearing 4500 and the directional weight 4600 offset the rotational force transmitted from the rotating member 4200 and thus prevent the second fixing member 4300 from being rotated.

As described above, since one end of the connecting shaft 4220 is inserted into the rotating member 4100 and the other end thereof is inserted into the installation groove 4211, the rotating member 4100 and the first fixing member 4200 are connected to be rotated independently from each other, and thus the rotational force of the rotating member 4100 transmitted to the first fixing member 4200 is reduced.

Further, since the third bearing 4800 is disposed between the inner surface of the installation groove 4211 and the outer circumference of the other end of the connecting shaft 4220, the friction between the connecting shaft 4220 and the rotating member 4100 is reduced and the rotational force of the rotating member 4100, which is transmitted to the connecting shaft 4220, is also reduced, thereby minimizing the rotational force of the rotating member 4100 which is transmitted to the second fixing member 4300.

Further, the third bearing 4800 is disposed in a circumferential direction of the second bearing 4500 so as to reduce the space between the rotating member 4100 and the second fixing member 4300, thereby reducing a whole thickness of the wheel cover.

### Fifth Embodiment

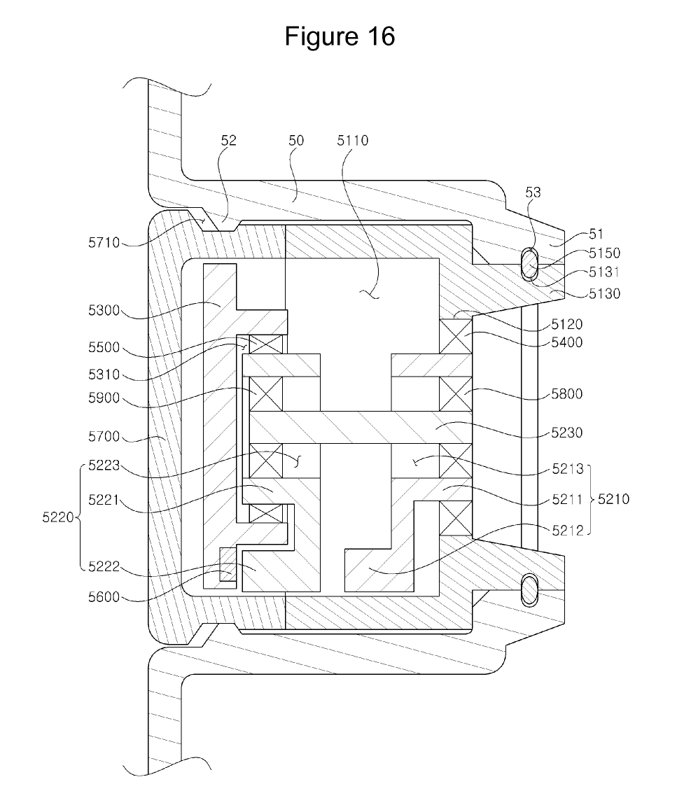

As shown in FIG. 16, a wheel cover for a vehicle according to a fifth embodiment of the present invention includes a rotating member 5100, a first fixing member 5200, a second fixing member 5300, a first bearing 5400, a second bearing 5500, a third bearing 5800, a fourth bearing 5900, a directional weight 5600 and a protective cover 5700.

The rotating member 5100, the second fixing member 5300, the directional weight 5600 and the protective cover 5700 in the fifth embodiment are the same as those in the second embodiment, and thus description thereof will be omitted.

The first fixing member 5200 includes a first deceleration member 5210, a second deceleration member 5220 and a connecting shaft 5230.

The first deceleration member 5210 includes a first connecting portion 5211 and a first deceleration weight 5212.

The connecting portion 5211 is formed into a cylindrical shape and inserted into a second insertion groove 5120 of the rotating member 5100. And the first connecting portion 5211 is formed with a first installation groove 5213 which is opened forward and backward.

The first deceleration weight 5212 is formed into a rectangular shape and disposed to be protruded to a lower side of the first connecting portion 5211. Further, a lower end of the first acceleration weight 5212 is further protruded toward the front side than the first connecting portion 5211, and the lower end of the first acceleration weight 5212 is thicker than an upper end thereof, and the first acceleration weight 5212 is heavier than the first connecting portion 5211.

The second deceleration 5220 includes a second connecting portion 5221 and a second deceleration weight 5222 and has the same configuration as the first acceleration member 5210 except that a lower end of the second deceleration weight 5222 is further protruded to the rear side than the second connecting portion 5221, and thus description thereof will be omitted.

Further, the second connecting portion 5221 is formed with a second installation groove 5223 which is the same as the first installation groove 5213.

The connecting shaft 5230 is formed into a cylindrical shape which is extended forward and backward. One end of the connecting shaft 5230 is inserted into the first installation groove 5213 and the other end thereof is inserted into the second installation groove 5223.

The first, second, third and fourth bearings 5400, 5500, 5800 and 5900 have the same configuration as the first bearing 1400 in the first embodiment, and thus description thereof will be omitted.

Further, the first and second bearings 5400 and 5500 have the same inner diameter, and the third and fourth bearings 5800 and 5900 having the same inner and outer diameters. The outer diameters of the third and fourth bearings 5800 and 5900 are smaller than the inner diameters of the first and second bearings 5400 and 5500.

The first bearing 5400 is disposed between an inner circumference of the rotating member 5100 and an outer circumference of the first connecting portion 5211 so that the rotating member 5100 and the first deceleration member 5210 are connected to be rotated independently from each other. That is, an outer circumference of the first bearing 5400 is fixed to the inner surface of the second insertion groove of the rotating member 5100, and an inner circumference thereof is fixed to the outer circumference of the first connecting portion 5211.

The second bearing is disposed between an inner circumference of a second insertion shaft 5310 and an outer circumference of the second connecting portion 5221 so that the second fixing member 5300 and the second deceleration member 5220 are connected to be rotated independently from each other. That is, an outer circumference of the second bearing 5500 is fixed to the inner surface of the groove formed in the second insertion shaft 5310, and an inner circumference thereof is fixed to the outer circumference of the second connecting portion 5221.

The third bearing 5800 is disposed between an inner surface of the first installation groove 5213 and an outer circumference of one end of the connecting shaft 5230 so that the first deceleration member 5210 and the connecting shaft 5230 are connected to be rotated independently from each other. That is, an outer circumference of the third bearing 5800 is fixed to the inner surface of the first installation groove 5213, and an inner circumference thereof is fixed to the outer circumference of one end of the connecting shaft 5230.

The fourth bearing 5900 is disposed between an inner surface of the second installation groove 5223 and an outer circumference of the other end of the connecting shaft 5230 so that the second deceleration member 5220 and the connecting shaft 5230 are connected to be rotated independently from each other. That is, an outer circumference of the fourth bearing 5900 is fixed to the inner surface of the second installation groove 5223, and an inner circumference thereof is fixed to the outer circumference of the other end of the connecting shaft 5230.

In the wheel cover according to the fifth embodiment of the present invention, when the rotating member 5100 is rotated, the rotational force of the rotating member 5100 is transmitted through the first bearing 5400 to the first deceleration member 5210, and the first deceleration member 5210 offsets the rotational force transmitted from the rotating member 5100 using the first deceleration weight 5212 and then transmits the offset rotational force to the third bearing 5800.

And the rotational force transmitted from the third bearing 5800 is transmitted through the connecting shaft 5230 and the fourth bearing 5900 to the second deceleration member 5220, and the second deceleration member 5220 completely offsets the rotational force transmitted from the rotating member 5100 using the second deceleration weight 5222.

Further, if the rotational force transmitted from the rotating member 5100 is not completely offset at the second deceleration member 5220 or the second deceleration member 5220 is rotated at a desired angle by inertial force, the rotational force of the second deceleration member 5220 is transmitted through the second bearing 5500 to the second fixing member 5300, and the second fixing member 5300 completely offsets the rotational force transmitted from the second deceleration member 5220 using the directional weight 5600.

As described above, since the third bearing 5800 is disposed between the first deceleration member 5210 and the connecting shaft 5230 and the fourth bearing 5900 is disposed between the second deceleration member 5220 and the connecting shaft 5230, it is possible to reduce friction between the first deceleration member 5210 and the connecting shaft 5230 and between the second deceleration member 5220 and the connecting shaft 5230 and also to reduce the rotational force of the connecting shaft 5230, which is transmitted to the second acceleration member 5220, thereby minimizing the rotational force of the rotating member 5100, which is transmitted to the second fixing member 5300.

### INDUSTRIAL APPLICABILITY

According to the present invention, the wheel cover with the advertisement is attached to the wheel. The wheel cover can be maintained in a stationary state, even when the wheel is rotated, and thus the advertisement can be shown clearly and visually from the outside.

While the present invention has been described with respect to the specific embodiments, it will be apparent to those skilled in the art that various changes and modifications may be made without departing from the spirit and scope of the invention as defined in the following claims.

1. A wheel cover for a vehicle, comprising:
a rotating member which is mounted on a wheel of the vehicle so as to be rotated together with the wheel when the driving wheel is rotated;
a first fixing member which is connected to the rotating member so as to be independently rotatable, and which is provided with a deceleration weight;
a second fixing member which is connected to the first fixing member so as to be independently rotatable and which is provided with an advertisement unit and also formed with a second insertion shaft protruded toward the first fixing member;
a first bearing which is disposed between the first fixing member and the rotating member such that the first fixing member and the rotating member are connected to be rotated independently from each other;
a second bearing which is disposed between the first fixing member and the second insertion shaft such that the first fixing member and the second insertion shaft are connected to be rotated independently from each other; and
a directional weight which is installed at the second fixing member,
wherein a center point of gravity of the second fixing member is located on a vertical line to a rotational center of the second fixing member, and
the center point of gravity of the second fixing member is located to be closer to an outer circumference of the second insertion shaft than an outer circumference of the second fixing member, and
two directional weights are provided to be symmetric with respect to the rotational center of the second fixing member.

2. The wheel cover according to claim 1, wherein a first fixing portion is formed at a rear side of the rotational member so as to be protruded and connected to the wheel, and a second fixing portion is formed at an inner circumference of the wheel, and a fixing ring which has an oval shape in section and functions to couple the rotational member and the wheel to each other so that the rotational member and the wheel are rotated together is installed at the first and second fixing portions, and a first fixing groove in which an inner circumference of the fixing ring is inserted is formed in an outer circumference of the first fixing portion so as to be passed through in a circumferential direction of the rotational member, and the a second fixing groove in which an outer circumference of the fixing ring is inserted is formed in an outer circumference of the first fixing portion so as to be opposed to the first fixing groove.

3. The wheel cover according to claim 2, wherein a stopper inserted into a stopping groove formed in the inner circumference of the wheel so as to have a trapezoidal shape of which an inner width becomes narrow from a front side toward a rear side thereof is protruded on an outer surface of the rotating member, thereby preventing the rotating member from being rotated independently with respect to the wheel.

4. The wheel cover according to claim 1, wherein a first fixing portion is formed at a rear portion of the rotating member so as to be protruded and connected to the wheel, and a second fixing member is formed on the inner circumference of the wheel, and
the first fixing portion comprises an extended portion which is extended backward, a hooking portion which is slantly bent from a rear end of the extended portion toward the outer circumference of the rotating member, and the second fixing portion is formed into a trapezoidal shape and protruded from the inner circumference of the wheel toward the first fixing portion, and
a rear surface of the second fixing portion comes into contact with the hooking portion and prevents the rotating member from being moved to a front side of the wheel, and the first fixing portion is separated from the rotating member and fastened to a rear portion of the rotating member by a screw.

5. The wheel cover according to a claim 1, wherein the first fixing member comprises a first connecting portion which is protruded to and inserted into the rotating member; a second connecting portion which is protruded in an opposite direction of the rotating member and inserted into the second insertion shaft of the second fixing member; and a deceleration weight which is disposed between the first and second connecting portions to be protruded to a lower side of a rotational center of the first fixing member, and
the first bearing is disposed between the inner circumference of the rotating member and the outer circumference of the first connecting portion, and the second bearing is disposed between the inner circumference of the second insertion shaft and the outer circumference of the second connecting portion.

6. The wheel cover according to claim 1, wherein the first fixing member comprises a connecting portion which is inserted into the second insertion shaft of the second fixing member and has an installation groove formed therein; and a deceleration weight which is disposed to be protruded to a lower side of a connecting portion, and
a third insertion shaft which is inserted into the installation groove is formed in the rotating member, and
the first bearing is disposed between an inner surface of the installation groove and an outer circumference of the third insertion shaft, and the second bearing is disposed between the inner circumference of the second insertion shaft and an outer circumference of the connecting portion.

7. The wheel cover according to claim 2, wherein the first fixing member comprises a first connecting portion which is protruded to and inserted into the rotating member; a second connecting portion which is protruded in an opposite direction of the rotating member and inserted into the second insertion shaft of the second fixing member; and a deceleration weight which is disposed between the first and second connecting portions to be protruded to a lower side of a rotational center of the first fixing member, and
the first bearing is disposed between the inner circumference of the rotating member and the outer circumference of the first connecting portion, and the second bearing is disposed between the inner circumference of the second insertion shaft and the outer circumference of the second connecting portion.

8. The wheel cover according to claim 3, wherein the first fixing member comprises a first connecting portion which is protruded to and inserted into the rotating member; a second connecting portion which is protruded in an opposite direction of the rotating member and inserted into the second insertion shaft of the second fixing member; and a deceleration weight which is disposed between the first and second connecting portions to be protruded to a lower side of a rotational center of the first fixing member, and
the first bearing is disposed between the inner circumference of the rotating member and the outer circumference of the first connecting portion, and the second bearing is disposed between the inner circumference of the second insertion shaft and the outer circumference of the second connecting portion.

9. The wheel cover according to claim 4, wherein the first fixing member comprises a first connecting portion which is protruded to and inserted into the rotating member; a second connecting portion which is protruded in an opposite direction of the rotating member and inserted into the second insertion shaft of the second fixing member; and a deceleration weight which is disposed between the first and second connecting portions to be protruded to a lower side of a rotational center of the first fixing member, and
the first bearing is disposed between the inner circumference of the rotating member and the outer circumference of the first connecting portion, and the second bearing is disposed between the inner circumference of the second insertion shaft and the outer circumference of the second connecting portion.

10. The wheel cover according to claim 2, wherein the first fixing member comprises a connecting portion which is inserted into the second insertion shaft of the second fixing member and has an installation groove formed therein; and a deceleration weight which is disposed to be protruded to a lower side of a connecting portion, and
a third insertion shaft which is inserted into the installation groove is formed in the rotating member, and
the first bearing is disposed between an inner surface of the installation groove and an outer circumference of the third insertion shaft, and the second bearing is disposed between the inner circumference of the second insertion shaft and an outer circumference of the connecting portion.

11. The wheel cover according to claim 3, wherein the first fixing member comprises a connecting portion which is inserted into the second insertion shaft of the second fixing member and has an installation groove formed therein; and a deceleration weight which is disposed to be protruded to a lower side of a connecting portion, and
a third insertion shaft which is inserted into the installation groove is formed in the rotating member, and
the first bearing is disposed between an inner surface of the installation groove and an outer circumference of the third insertion shaft, and the second bearing is disposed between the inner circumference of the second insertion shaft and an outer circumference of the connecting portion.

12. The wheel cover according to claim 4, wherein the first fixing member comprises a connecting portion which is inserted into the second insertion shaft of the second fixing member and has an installation groove formed therein; and a deceleration weight which is disposed to be protruded to a lower side of a connecting portion, and
a third insertion shaft which is inserted into the installation groove is formed in the rotating member, and
the first bearing is disposed between an inner surface of the installation groove and an outer circumference of the third insertion shaft, and the second bearing is disposed between the inner circumference of the second insertion shaft and an outer circumference of the connecting portion.
